(19) United States
(12) Patent Application Publication
(10) Pub. No.: US 2024/0015540 A1
(43) Pub. Date: Jan. 11, 2024

(54) TECHNIQUES FOR REDUCED SIGNALING IN MULTILINK OPERATIONS

(71) Applicant: Cisco Technology, Inc., San Jose, CA (US)

(72) Inventors: Pooya MONAJEMI, San Jose, CA (US); Juan Carlos ZUNIGA, Montreal (CA)

(21) Appl. No.: 18/052,057

(22) Filed: Nov. 2, 2022

Related U.S. Application Data
(60) Provisional application No. 63/368,030, filed on Jul. 8, 2022.

(51) Int. Cl. H04W 24/08; H04L 5/00; H04W 52/02

(52) U.S. Cl. CPC H04W 24/08; H04L 5/0055; H04W 52/0212; H04W 88/06

(57) ABSTRACT

Techniques for more efficient multilink operations are provided. A first multilink device (MLD) determines to use reduced signaling multilink operations (MLO) with a second MLD. The first MLD engages in reduced signaling MLO with the second MLD, comprising: transmitting, to the second MLD, a first set of data frames via a first link of a plurality of links, receiving, from the second MLD, an acknowledgement frame for the first set of data frames, and transmitting, to the second MLD, a second set of data frames without transmitting an initial control frame for the second set of data frames.

### CROSS-REFERENCE TO RELATED APPLICATIONS

This application claims benefit of co-pending U.S. provisional patent application Ser. No. 63/368,030 filed Jul. 8, 2022. The aforementioned related patent application is herein incorporated by reference in its entirety.

### TECHNICAL FIELD

Embodiments presented in this disclosure generally relate to network transmissions. More specifically, embodiments disclosed herein relate to more efficient reduced signaling techniques in multilink operations.

### BACKGROUND

In a variety of telecommunications systems, participating devices on either end of a transmission are often capable of using multiple connections or links (either in the alternative or in combination). A link can generally be any connection between nodes or points in the network, including wired, wireless, or a combination of wired and wireless links, such as between communicating devices (e.g., two client devices), between an access point and a client device, and the like. One example technology used for multilink operations (MLO) is Enhanced Multi-Link Single Radio (eMLSR). Generally, eMLSR devices are a category of multilink devices (MLD) that generally operate one main wireless radio that can transmit and/or receive data frames on a given link, but can detect some data (e.g., short initial frames) on a set of other links when the device is not actively transmitting or receiving.

In many conventional systems (such as in conventional MLSR and/or eMLSR MLO), the participating MLD(s) must transmit one or more initial control frames to indicate which link will be used for the upcoming data transmission. For example, the access point (AP) may send a control frame on a specific link to indicate that the specific link will be used for the next data transmission. The receiving MLD can then switch to this specific link. However, this initial frame adds to the latency of any downlink traffic, and can also consume a significant amount of air time, especially in traffic conditions where bursts of short data are transmitted. Further, these initial frames add to the power consumption on the devices when receiving and decoding the data, along with the cost of a potential band switch, which reduces the efficacy of such approaches for a variety of resource-constrained devices.

### BRIEF DESCRIPTION OF THE DRAWINGS

So that the manner in which the above-recited features of the present disclosure can be understood in detail, a more particular description of the disclosure, briefly summarized above, may be had by reference to embodiments, some of which are illustrated in the appended drawings. It is to be noted, however, that the appended drawings illustrate typical embodiments and are therefore not to be considered limiting; other equally effective embodiments are contemplated.

FIG. 1 depicts an example environment for reduced signaling multilink operations.

FIG. 2 depicts example transmissions for reduced signaling multilink operations.

FIG. 3 is a flow diagram depicting an example method for reduced signaling multilink operations.

FIG. 4 is a flow diagram depicting an example method for reduced signaling multilink operations using target wake time negotiations.

FIG. 5 is a flow diagram depicting an example method for reduced signaling multilink operations using requests to stay.

FIG. 6 is a flow diagram depicting an example method for reduced signaling multilink operations using cross-link signaling.

FIG. 7 is a flow diagram depicting an example method for reduced signaling multilink operations using extended communication durations.

FIG. 8 is a flow diagram depicting an example method for reduced signaling multilink operations.

FIG. 9 depicts an example computing device configured to perform various aspects of the present disclosure.

To facilitate understanding, identical reference numerals have been used, where possible, to designate identical elements that are common to the figures. It is contemplated that elements disclosed in one embodiment may be beneficially used in other embodiments without specific recitation.

### DESCRIPTION OF EXAMPLE EMBODIMENTS

### Overview

One embodiment presented in this disclosure provides a method, comprising: determining, by a first multilink device (MLD), to use reduced signaling multilink operations (MLO) with a second MLD; engaging in reduced signaling MLO with the second MLD, comprising: transmitting, to the second MLD, a first set of data frames via a first link of a plurality of links; receiving, from the second MLD, an acknowledgement frame for the first set of data frames; and transmitting, to the second MLD, a second set of data frames without transmitting an initial control frame for the second set of data frames.

Other embodiments in this disclosure provide non-transitory computer-readable mediums containing computer program code that, when executed by operation of one or more computer processors, performs operations in accordance with one or more of the above methods, as well as systems comprising one or more computer processors and one or more memories containing one or more programs which, when executed by the one or more computer processors, performs an operation in accordance with one or more of the above methods.

### Example Embodiments

Aspects of the present disclosure provide techniques for improved MLO efficiency via reduced signaling. In some embodiments, the reduced signaling corresponds to reduced (or eliminated) need for initial control frames during the MLO transmissions. In some examples discussed herein, MLSR and/or eMLSR operations are used as one example MLO technique that can be improved using embodiments of the present disclosure. However, embodiments of the present disclosure are readily applicable to a wide variety of MLO systems and architectures

In conventional systems, each time an AP transmits a downlink frame or data to an eMLSR device, the AP must first initiate the frame exchange by sending an initial control frame (also referred to as a trigger frame, an initial frame, an initialization frame, and the like), such as a request to send (RTS) frame or a multiuser RTS (MU-RTS) frame, in order to signal, to the eMLSR client device, which link will be used for the main (data) transmission. Often, the MU-RTS frame needs to be padded to a minimum length such that enough time is allowed for the receiving client device's main radio to switch to the appropriate operating band. However, these initial frames waste airtime and can result in significant inefficiencies in a variety of environments and circumstances.

In embodiments of the present disclosure, the participating MLDs can enable reduced signaling and avoid one or more initial frames using a variety of techniques. Generally, by engaging in some advanced or prior negotiation or agreement regarding link usage, the MLDs may avoid future initial control frames and improve network and communication efficiency while reducing resource consumption.

For example, in some embodiments, if there has been a prior frame exchange on a given link, new flags or other data may be used or inserted (e.g., along with one or more data frames) to signal the availability of the device on the same link for one or more future transmissions or for a duration of time. In one embodiment, the flag(s) may indicate information such as a duration for which the device will stay on the link. In at least one embodiment, the AP device may send a flag along with the more-data bit, recommending or requesting that the receiving device stay on link for the next transmission. In some embodiments, the receiving device may acknowledge and accept this recommendation (e.g., using a bit in the media access control (MAC) header of the response frame (e.g., an ACK, BA, and the like). In this way, additional exchanges may be performed without the need for additional initial control frames.

As another example, in some embodiments, the MLDs can use target wake time (TWT) and/or restricted TWT (rTWT) to negotiate or agree, in advance, which link will be used (e.g., to indicate that the device will be fully available on the specified link on which the TWT is scheduled). In an embodiment, this agreement may be signaled as part of the TWT negotiation itself, or implicitly given as a capability in the device (e.g., where the other device can infer or determine that the initiating device will be present on the specific link at the specific time, based on a defined configuration or known capability of the initiating device). In this way, the MLO can begin at the TWT on the corresponding link without the need for an initial control frame.

As another example, in some embodiments, the MLDs can use cross-link signaling to negotiate or agree, in advance, which link will be used for some future transmission. For example, while communicating using a first link, either MLD may include a frame, field, or other data element indicating the MLD's plan to switch to another link at some specified time in the future. In this way, an additional initial control frame for the other link is not needed.

As another example, in some embodiments, the MLDs can an additional field or element in the initial control frame to negotiate or agree, in advance, a duration or other terms of using the link. For example, in the initial control frame for an eMLSR transmission (e.g., a MU-RTS frame used to identify the link that the MLD will use), the transmitting device may include an additional duration field (longer than the transmission opportunity (TxOP)) allocated by the same initial control frame. That is, the MLD may transmit an initial control frame specifying a TxOP (e.g., a duration of the current transmission), as well as a duration indicating the length of time and/or number of frames during which the MLD will continue to use the same link. The receiving MLD is thereby requested to stay on the link for the additional data frames, and additional initial control frames need not be sent.

In some embodiments, additional signaling may be introduced to enable breaking or termination of any previously agreed stays. For example, if an MLD determines that channel access is poor on the link that the devices agreed to use (e.g., due to a long TxOP by another device), the device may switch links and/or send a notification that the previously-agreed stay is canceled using various techniques, such as embedding it in an initial control frame or response frame, sending a separate frame, and the like. This signal may be transmitted in another link.

In some embodiments, the participating device(s) may determine or decide whether to use reduced signaling MLO based on a variety of criteria (e.g., because reduced signaling may be particularly beneficial in some circumstances).

As one example, depending on the ongoing traffic patterns, embodiments of the present disclosure can provide substantial efficiencies. For example, if the traffic consists of frequent and short frames (e.g., above a defined frequency and/or below a defined frame size), more air time is wasted on the initial frames, and reduced signaling may be significantly more efficient, as compared to conventional approaches, when such traffic patterns are present. In some embodiments, detecting such traffic patterns can be performed by evaluating data over a window of time (e.g., average transmission size, frequency, and the like), or via one or more other traffic indication techniques (such as traffic specification (TSPEC)).

As another example, the MLD(s) may consider medium access in determining whether to use reduced signaling MLO. For example, the MLD(s) may estimate medium access times on each link (e.g., how much time is expected to pass until access to the medium/link is available again, if the MLD releases the link). This information may be derived from a variety of data sources, such as channel utilization measurements. If the predicted access time is long (e.g., it will take a long period of time to regain the medium), the MLD may determine to use reduced signaling MLO to retain the medium and improve efficiency of the transmissions.

As another example, the MLD(s) may consider latency sensitivity on the link and/or whether latency-sensitive traffic is being transmitted via the link. For example, latency-sensitive traffic may suffer more loss or inefficiency due to the overhead introduced by initial control frames, as compared to other traffic. As another example, the MLD(s) may determine or estimate the total air time being dedicated to the initial/trigger frames. If the air time meets or exceeds some threshold, the MLD(s) may determine to switch to reduced signaling MLO.

As yet another example, the MLD(s) may determine to use reduced signaling MLO to reduce power consumption, as the number of control frames can have a significant impact on the overall power requirements of the devices to send the same amount of useful data.

In some embodiments, the MLD(s) determine to use reduced signaling MLO based on evaluating the buffer state, routing or rate state of the links, and the like. For example, to select an optimized duration of an on-link stay, the buffer state may be considered (along with the rate selection statistics, in some aspects) to estimate or determine a predicted air time that will be required to transmit or empty the current buffer. If the current link has a high data rate and/or the buffer can be emptied quickly, it may be more advantageous to remain on the same link.

In at least one embodiment, the MLD(s) may consider the TxOP maximum duration and/or statistics related to recent TxOPs. That is, the MLD(s) may consider the probability of regaining medium access after completion of the current TxOP, along with the potential risks of other device(s) gaining the medium for the next TxOP.

Generally, the system may consider a wide variety of alternatives and statistics when determining whether to engage in reduced signaling MLO, as well as when determining which technique(s) or approaches for reduced signaling MLO are most appropriate. In some embodiments, rather than evaluating such criteria, the MLD(s) can use reduced signaling MLO whenever it is available (e.g., whenever both devices support it), regardless of the traffic state or context.

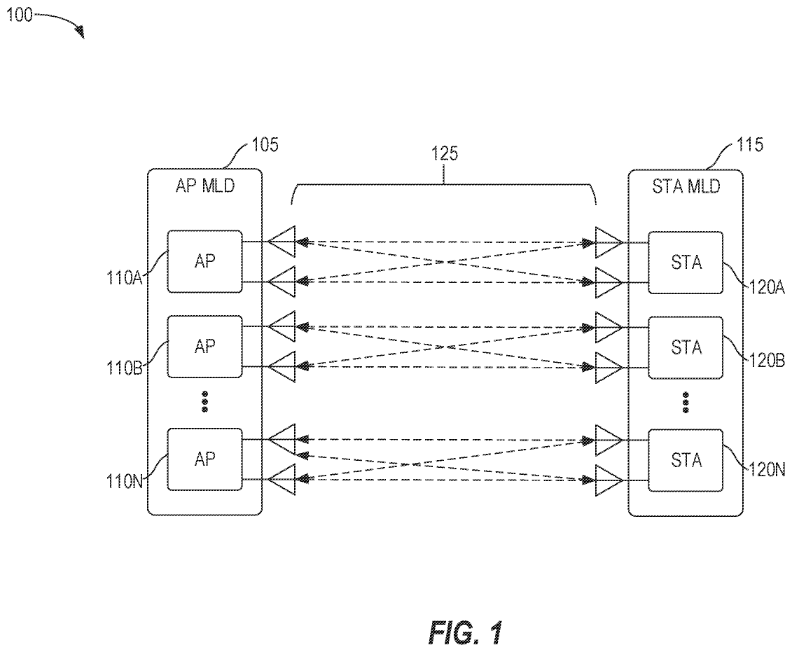

FIG. 1 depicts an example environment 100 for reduced signaling multilink operations.

In the illustrated environment 100, an AP MLD 105 (e.g., an access point that acts as a multilink device) is communicatively coupled with a STA MLD 115 (e.g., a station or client device acting as a multilink device) via a set of links 125. In some embodiments the links 125 correspond to wireless connections. In some embodiments, a link 125 exists between each antenna of the AP MLD 105 and each antenna of the STA MLD 115. In the illustrated example, links 125 exist between each AP 110 and a corresponding STA 120. For example, the AP 110A has one or more links connecting it to the STA 120A, AP 1108 and STA 1208 are connected by one or more links, and so on. That is, each linked AP/STA pair may operate using a different frequency, as compared to other AP/STA pairs. For example, the AP 110A and STA 120A may use a first frequency band (e.g., 2.4 GHz) while AP 1108 and STA 120B use a second band (e.g., 5 GHz).

The AP MLD 105 and STA MLD 115 are generally representative of any device capable of performing multilink operations. For example, the AP MLD 105 and STA MLD 115 may be configured to or capable of using eMLSR techniques.

As illustrated, the AP MLD 105 includes a number of individual APs 110A-N, where each AP 110A-N has one or more antenna. Although three APs 110 are depicted for conceptual clarity, in embodiments, the AP MLD 105 may use any number of APs 110 (including one). Similarly, though the APs 110 each have two antenna in illustrated example, in embodiments, each AP 110 may have any number of antenna (including one). Additionally, in the illustrated embodiment, the STA MLD 115 includes a number of individual STAs 120A-N, where each STA 120A-N has one or more antenna. Although three STAs 120 are depicted for conceptual clarity, in embodiments, the STA MLD 115 may use any number of STAs 120 (including one). Similarly, though the STAs 120 each have two antenna in illustrated example, in embodiments, each STA 120 may have any number of antenna (including one).

In some embodiments of the present disclosure, AP MLDs 105 and STA MLDs 115 may generally be referred to collectively as “MLDs” or “multilink devices,” indicating that they are capable of using multiple communication links 125 (whether using one link at a time, or using multiple links in parallel to transmit and receive data). Additionally, in some embodiments, the AP MLD 105 may be generally referred to as simply an “AP,” and the STA MLD 115 may generally be referred to as simply a “STA” or “client device.” Generally, the AP MLD 105 corresponds to an access point device that provides connectivity to a local wireless network (e.g., WiFi), while the STA MLD 115 corresponds to a station or client device connected to the local wireless network via the AP MLD 105.

In at least one embodiment, the AP MLD 105 and/or STA MLD 115 may be able to transmit and receive data on a single link at a time, and/or listening passively on one or more other links. That is, the MLDs may be configured to transmit/receive on one link while listening on one or more other links, or may be configured to either transmit/receive on one link, or listen passively on multiple links. In this way, when an initial control frame is received on any link (which may be the same link or a different link than the link currently being used, if any), the AP MLD 105 and/or STA MLD 115 can switch to the indicated link for the subsequent transmission. Additionally, in conventional systems, the initial control frames are transmitted even when the device(s) are not switching to a new link. That is, the initiating MLD will still send an initial control frame using the same (currently-active) link, and both devices will remain. However, as discussed above, these initial control frames can consume substantial air time.

For example, using conventional eMLSR, the AP MLD 105 and STA MLD 115 may exchange frames using a first link 125 (e.g., connecting AP 110A to STA 120A). At the end of the TxOP/exchange, the AP MLD 105 and/or STA MLD 115 may transmit an initial control frame on the same link 125 or another link (e.g., a link connecting AP 1108 and STA 120B). If this initial control frame is accepted/acknowledged, both devices may use the corresponding link for the subsequent TxOP.

However, using embodiments of the present disclosure, the AP MLD 105 and STA MLD 115 may use reduced signaling MLO to reduce the number of such initial control frames that are needed/used, or eliminate them entirely. For example, as discussed above and in more detail below, the AP MLD 105 may include, in one or more frames of the ongoing transmission, an indication or request that the STA MLD 115 remain on the same link for the next TxOP. Similarly, the AP MLD 105 may include, in one or more control frames or other frames, an indication or request that the STA MLD 115 switch to a different (specified) link for the next TxOP. At the start of the next exchange, the AP MLD 105 and STA MLD 115 may begin using the indicated link without the need for an additional initial control frame.

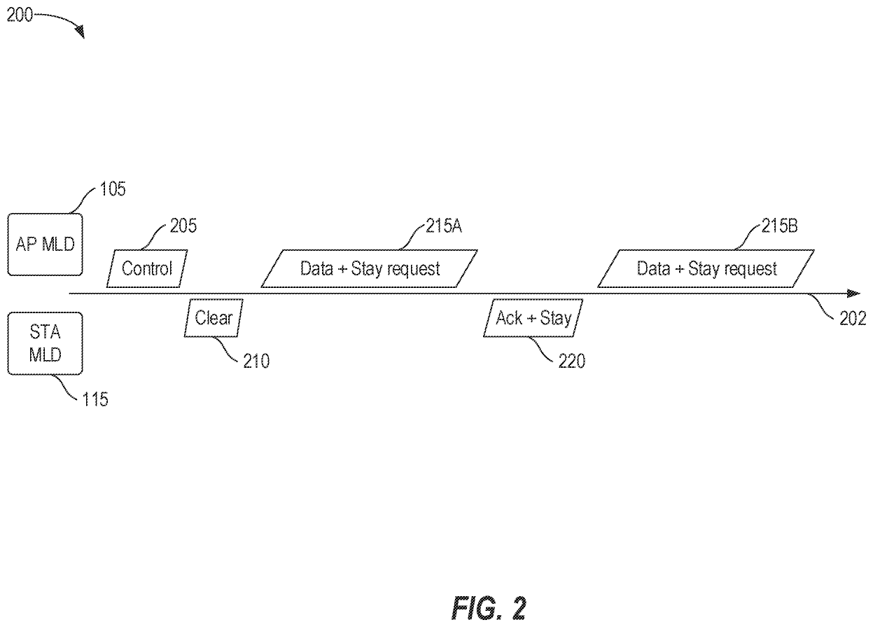

FIG. 2 depicts example transmissions 200 for reduced signaling multilink operations.

In the illustrated example, an AP MLD 105 and STA MLD 115 are engaging in a frame exchange, where blocks above the arrow 202 indicate frames transmitted from the AP MLD 105 to the STA MLD 115, blocks below the arrow 202 indicate frames transmitted from the STA MLD 115 to the AP MLD 105, and the arrow 202 represents the passage of time (e.g., where the frame(s) 205 are transmitted before the frame(s) 210, which are transmitted before the frame(s) 215A, and so on).

Though a single timeline arrow 202 is depicted for conceptual clarity, in the illustrated workflow, the AP MLD 105 and STA MLD 115 are using MLO to transmit and receive the transmissions 200. That is, though the illustrated example depicts transmissions on a single link, there may be other links (not depicted) used by the AP MLD 105 and STA MLD 115, as discussed above. As illustrated the AP MLD 105 can initiate the MLO using an initial control frame 205. In some embodiments, the initial control frame 205 may alternatively be referred to as a control frame, an initial frame, a multiuser request-to-send (MU-RTS) frame, and the like. Though the illustrated embodiment depicts the AP MLD 105 initiating the frame exchange, in embodiments, either MLD may initiate the transmission.

In some embodiments, the initial control frame 205 can be used to initiate the first transmission between the devices, and/or can be used when the devices are using conventional MLO (as opposed to reduced signaling MLO). As discussed above, the initial control 205 can generally be used to indicate that the AP MLD 105 intends to or requests to transmit the next set of frames (e.g., data frames 215A) via the link on which the initial control frame 205 is sent.

As illustrated, in response to the initial control frame 205, the STA MLD 115 can determine whether to accept the proposal (e.g., to initiate communications on the link). If so, the STA MLD 115 transmits a clear frame 210 to the AP MLD 105. In some embodiments, the clear frame 210 may alternatively be referred to as a control frame, a response frame, a clear-to-send (CTS) frame, and the like. In an embodiment, the clear frame 210 is transmitted using the link on which the initial control frame 205 was received.

As illustrated, in response to receiving the clear frame 210, the AP MLD 105 transmits one more data frames 215A, where one or more of the data frames 215A includes a stay request (e.g., a request that the STA MLD 115 stay on the same link for the next transmission). In conventional MLO, the data frames 215 do not include such a request. Instead, after receiving acknowledgement from the STA MLD 115, the TxOP/transmission ends, and the AP MLD 105 must send another new initial control frame 205 on a link to begin a new exchange on the link (regardless of whether the new exchange uses the same link or a different link). However, in the illustrated example, the AP MLD 105 initiates reduced signaling MLO by including the request with the data frames 215A, thereby obviating the need for an additional initial control frame.

As above, though the illustrated example depicts the AP MLD 105 initiating the reduced signaling operations, in embodiments, either MLD may initiate such operations (e.g., by including the stay request in a frame). In response to receiving the data frames 215A, the STA MLD 115 transmits an acknowledgement frame 220. In some embodiments, the acknowledgement frame 210 may alternatively be referred to as a control frame, an ACK frame, a block ACK (BA) frame, and the like. In the illustrated example, the STA MLD 115 can include an acceptance of the stay request in the acknowledgement frame 220. In conventional MLO systems, this acknowledgement frame 220 does not include such a response.

In this way, the data frame(s) 215A can replace the initial control frame 205, and the acknowledgement frame 220 can replace the clear frame 210. Accordingly, as illustrated, the AP MLD 105 can proceed directly to the next set of data frames 215B (rather than transmitting a new initial control frame). In the illustrated example, this new set of data frames 215B may optionally include another stay request.

Though the illustrated example depicts one technique for enabling reduced signaling MLO, as discussed above and below in more detail, other techniques are similarly-applicable. Generally, such techniques involve the AP MLD 105 and STA MLD 115 engaging in some negotiation or agreement prior to the transmissions. For example, in the illustrated embodiment, the negotiation is performed using the data frame(s) 215A and acknowledge frame 220. As additional examples, the STA MLD 115 and AP MLD 105 may agree to a TWT, where the AP MLD 105 and/or STA MLD 115 can immediately begin transmitting data frames at the target time using the indicated link (rather than transmitting an initial control frame).

Additionally, though the illustrated example depicts the AP MLD 105 requesting the stay, in some aspects, the STA MLD 115 may similarly transmit data frames (or other frames) including a stay request, which can be optionally accepted by the AP MLD 105, or a stay indication, which does not need to be accepted by the AP MLD. As another example, the AP MLD 105 and/or STA MLD 115 may include, in one or more frames (e.g., in the data frame(s) 215, the acknowledgement frame 220, and the like), an indication or request to switch to another specified link (rather than remaining on the current link).

As yet another example, the AP MLD 105 may include, in the initial control frame 205, an indicated duration (beyond the current TxOP) requesting that the STA MLD 115 remain on the current link until the duration expires. The STA MLD 115 may optionally accept this request (e.g., using the clear frame 210, the acknowledgement frame 220, and the like).

In any case, using the reduced signaling MLO, one or more subsequent frame exchanges can begin (e.g., beginning with data frames 215) without the need for another initial control frame 205. In this way, embodiments of the present disclosure can substantially reduce the air time consumed by such control frames, improving network efficiency and availability and reducing computational resource usage by each participating device.

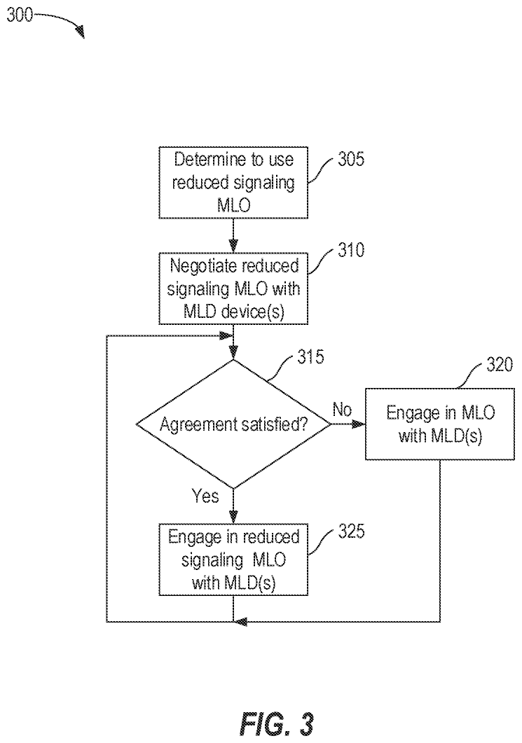

FIG. 3 is a flow diagram depicting an example method 300 for reduced signaling multilink operations. In some embodiments, the method 300 is performed by an AP MLD, such as AP MLD 105 of FIGS. 1 and 2. In some embodiments, the method 300 is performed by a STA MLD, such as STA MLD 115 of FIGS. 1 and 2.

At block 305, an MLD determines to use or engage in reduced signaling MLO for one or more subsequent frame exchanges with one or more other MLDs. For example, the MLD may determine whether the other MLD is capable of reduced signaling MLO, whether the current conditions or context (e.g., traffic conditions, network conditions, data rates, buffer states, and the like) meet defined criteria, and the like. As an example, the MLD may determine the average frequency of data frame transmissions over a window of time, and determine whether this frequency satisfies defined frequency criteria (e.g., a minimum frequency). Similarly, the MLD may determine the average data frame size being transmitted over a window of time, and determine whether the size meets defined size criteria (e.g., a minimum size). Relatedly, the MLD may determine whether the current traffic is indicated or defined as latency-sensitive, and/or determine whether the total or average air time being used by the initial control frame(s) meets or exceeds some criteria.

In some embodiments, a wide variety of triggering criteria can be used to determine whether reduced signaling MLO should be used. In at least one embodiment, no triggering criteria are used or needed, and the MLD can simply use the reduced signaling MLO for all transmissions (or for all transmissions with other MLD that are capable of or configured to use reduced signaling).

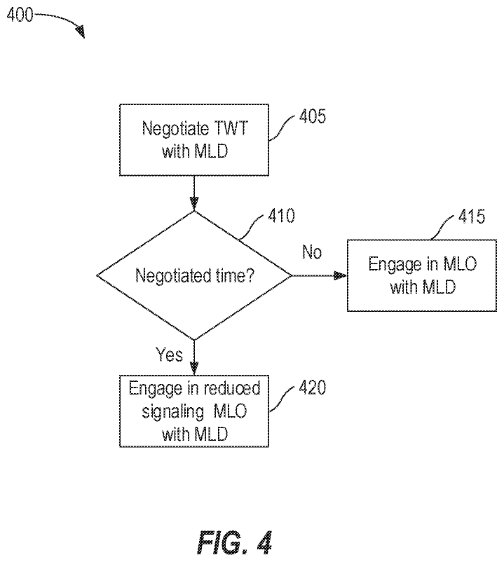

At block 310, the MLD negotiates the reduced signaling MLO with one or more other MLDs. As discussed above, this negotiation may include a wide variety of actions and operations, and generally involves agreeing to use a specified link at a future time (which may be specified as well) without the use of a dedicated initial control frame. For example, the negotiation may include TWT negotiations, cross-link negotiations, stay negotiations, duration negotiations, and the like. Some example reduced signaling negotiations and agreement techniques are described in more detail below with reference to FIGS. 4-7.

At block 315, the MLD determines whether the agreement, negotiated at block 310, is currently satisfied. For example, if the agreement included a TWT negotiation, the MLD may determine whether the indicated target time has arrived. Similarly, if the agreement included a stay negotiation (e.g., to remain on the current link beyond the current transmission/TxOP), the MLD can determine whether the current transmission is complete and/or whether the other MLD agreed to the stay.

If, at block 315, the MLD determines that the agreement is not satisfied, the method 300 continues to block 320, where the MLD engages in conventional or ordinary MLO with the MLD(s). For example, as discussed above, the MLD may transmit an initial control frame (e.g., a MU-RTS frame) or other control frame to the other MLD prior to beginning transmission of data frames (e.g., where the link used to transmit the initial control frame is also the link that the MLD will use to transmit the data frames). The method 300 then returns to block 315. In this way, the MLD can continue to evaluate whether any reduced signaling agreements are satisfied. In at least one embodiment, rather than returning to block 315, the method 300 returns to block 305 and/or 310, or terminates.

Returning to block 315, if the MLD determines that the agreement is satisfied (e.g., the negotiated target wake time has arrived), the method 300 continues to block 325, where the MLD engages in reduced signaling MLO with the other participating MLD(s). Generally, as discussed above, the reduced signaling MLO corresponds to the ability to transmit data frames on multiple discrete communication links (even if only a single link is used at a time) with reduced or eliminated need for dedicated control frames used to indicate which link will be used for a following transmission. That is, the link that will be used can be indicated or agreed upon using other means, rather than dedicated control frames.

In embodiments, the particular operations used to provide reduced signaling MLO may vary depending on the nature of the agreement between the MLDs. For example, in a “request to stay” embodiment, the MLD may embed the request in one or more data frames or other frames being transmitted to the other MLD. In a TWT embodiment, the MLDs may simply use whichever link the TWT was negotiated on as the link to be used at the indicated target time.

Generally, as discussed above, the reduced signaling MLO provides reduced network congestion and increased efficiency, while further reducing resource consumption (such as battery or power) and improving the overall functionality and operations of the network and of each participating MLD.

FIG. 4 is a flow diagram depicting an example method for reduced signaling multilink operations using target wake time negotiations. In some embodiments, the method 400 is performed by an AP MLD, such as AP MLD 105 of FIGS. 1 and 2. In some embodiments, the method 400 is performed by a STA MLD, such as STA MLD 115 of FIGS. 1 and 2.

At block 405, a first MLD negotiates a TWT, with a second MLD, for a future time. Generally, TWT is a power-saving mechanism that enables devices (e.g., client devices, such as a STA MLD) to reduce power consumption by sleeping for some time, only waking to process data, listen to transmissions, and/or transmit data at specified times or windows. In an embodiment, negotiating the TWT generally includes agreeing to the specific future time when the MLD will begin communicating/using the communication link again. If the initiating MLD is the AP MLD, the negotiation may begin with suggesting or requesting a time, while if the STA MLD initiates, the negotiation may begin with indicating the time. In some embodiments, negotiating the TWT includes specifying which link will be used at the indicated time. In at least one embodiment, the link to be used corresponds to the link being used to negotiate the TWT. That is, the MLDs need not specify a future link, and can determine to use the current link at the specified future time.

At block 410, the MLD determines whether the negotiated time has been reached. This may include, for example, determining whether a specified timer has expired, as well as determining whether the indicated global time has arrived. If not, the method 400 continues to block 415, where the MLD uses conventional MLO to communicate with one or more MLDs. In one embodiment, the MLD does not communicate with the second MLD (that participated in the TWT negotiation at block 405), as this MLD is expected to be unreachable at this time.

If, at block 410, the MLD determines that the negotiated time has arrived, the method 400 continues to block 420, where the MLD engages in reduced signaling MLO with the MLD. In some embodiments, as discussed above, the MLD can do so by immediately transmitting one or more data frames (e.g., data frames 215 of FIG. 2), without first transmitting any initial control frame, such as initial control frame 205 of FIG. 2 (e.g., without sending an RTS or MU-RTS frame to the MLD) and without awaiting a response or clear frame, such as clear frame 210 of FIG. 2 (e.g., without waiting to receive a CTS frame). In this way, the MLO are performed with reduced signaling (e.g., with no initial control frames).

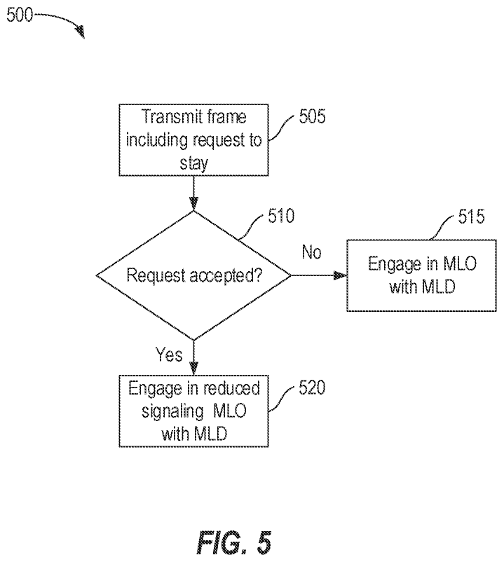

FIG. 5 is a flow diagram depicting an example method for reduced signaling multilink operations using requests to stay. In some embodiments, the method 500 is performed by an AP MLD, such as AP MLD 105 of FIGS. 1 and 2. In some embodiments, the method 500 is performed by a STA MLD, such as STA MLD 115 of FIGS. 1 and 2.

At block 505, a first MLD transmits a frame, to a second MLD, requesting that the second MLD remain or stay on the current link for at least one more transmission block or TxOP. For example, as discussed above, the initiating MLD may embed a flag or other indication (referred to in some embodiments as a “stay request”) in one or more frames that are being transmitted to the second MLD (e.g., in data frames 215 of FIG. 2).

At block 510, the MLD determines whether the request was accepted by the second MLD. This may include, for example, determining whether an acknowledgement frame (e.g., acknowledgement frame 220 of FIG. 2) was received, whether the received acknowledgement frame includes a flag or other label indicating that the stay request is accepted, and the like. If the request was not accepted, the method 500 continues to block 515, where the MLD proceeds to use conventional MLO to communicate with the second MLD. That is, because the second MLD declined to stay, the first MLD can use ordinary techniques and transmit an initial control frame on whichever link it determines to use next.

Although the illustrated example depicts the MLD determining whether the request was accepted, in some embodiments, the system may additionally or alternatively use a technique where the MLD need not “request” the stay, and the receiving device need not “accept” it. That is, in some embodiments, the triggering MLD may transmit an indication that it intends to stay on the same link, and the receiving device can obey this indication.

If, at block 510, the MLD determines that the request was accepted (or that no acceptance was needed, such as if the MLD transmitted an indication or instruction, rather than a request), the method 500 continues to block 520, where the MLD engages in reduced signaling MLO with the MLD. In some embodiments, as discussed above, the MLD can do so by immediately transmitting one or more additional data frames (e.g., data frames 215 of FIG. 2) for the subsequent TxOP, without first transmitting any initial control frame, such as initial control frame 205 of FIG. 2 (e.g., without sending an RTS or MU-RTS frame to the MLD) and without awaiting a response or clear frame, such as clear frame 210 of FIG. 2 (e.g., without waiting to receive a CTS frame). In this way, the MLO are performed with reduced signaling (e.g., with no initial control frames).

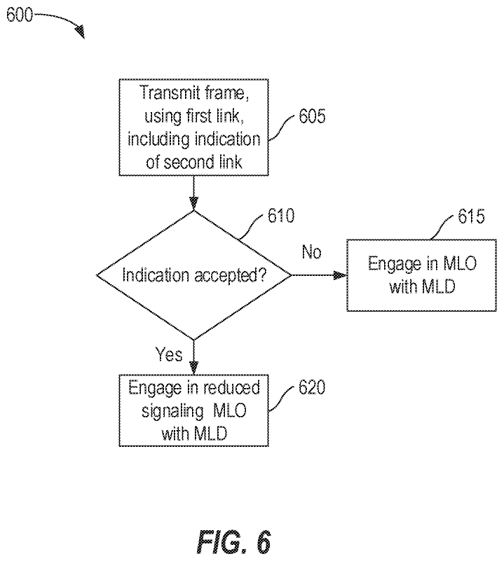

FIG. 6 is a flow diagram depicting an example method for reduced signaling multilink operations using cross-link signaling. In some embodiments, the method 600 is performed by an AP MLD, such as AP MLD 105 of FIGS. 1 and 2. In some embodiments, the method 600 is performed by a STA MLD, such as STA MLD 115 of FIGS. 1 and 2.

At block 605, a first MLD transmits, to a second MLD, an indication of a second link, where the indication is transmitted using a first (current) link. For example, the first MLD may embed a flag or other label in a frame (e.g., a control frame or a data frame) indicating that, although the current frame(s) are being transmitted on the first link, the MLD intends or plans to use the indicated second link for a subsequent transmission opportunity.

At block 610, the MLD determines whether the indication was accepted. This may include, for example, determining whether an acknowledgement frame (e.g., acknowledgement frame 220 of FIG. 2) was received, whether the received acknowledgement frame includes a flag or other label indicating that the cross-link request is accepted, and the like. If the request was not accepted, the method 600 continues to block 615, where the MLD proceeds to use conventional MLO to communicate with the second MLD. That is, because the second MLD declined to use or switch to the other link, the first MLD can use ordinary techniques and transmit an initial control frame on whichever link it determines to use next.

If, at block 610, the MLD determines that the indication was accepted, the method 600 continues to block 620, where the MLD engages in reduced signaling MLO with the MLD. In some embodiments, as discussed above, the MLD can do so by immediately transmitting one or more data frames (e.g., data frames 215 of FIG. 2) on the second link (indicated at block 605), without first transmitting any initial control frame, such as initial control frame 205 of FIG. 2 (e.g., without sending an RTS or MU-RTS frame to the MLD) on the second link and without awaiting a response or clear frame, such as clear frame 210 of FIG. 2 (e.g., without waiting to receive a CTS frame) on the second link. In this way, the MLO are performed with reduced signaling (e.g., with no initial control frames).

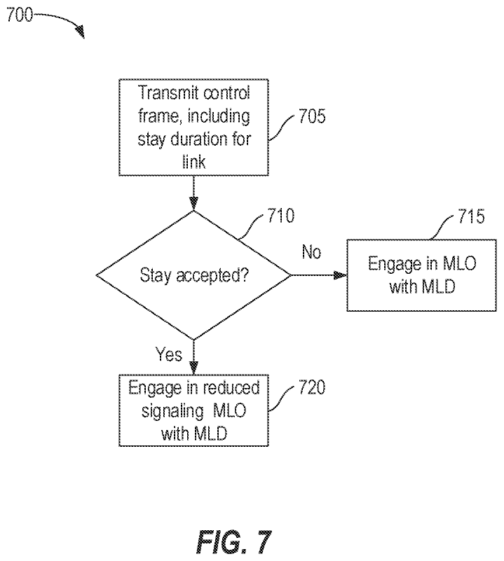

FIG. 7 is a flow diagram depicting an example method for reduced signaling multilink operations using extended communication durations. In some embodiments, the method 700 is performed by an AP MLD, such as AP MLD 105 of FIGS. 1 and 2. In some embodiments, the method 700 is performed by a STA MLD, such as STA MLD 115 of FIGS. 1 and 2.

At block 705, a first MLD transmits a frame, to a second MLD, requesting that the second MLD remain or stay on the current link for a specified duration (beyond the length of the current transmission or TxOP). For example, as discussed above, the initiating MLD may embed a flag or other indication in one or more frames that are being transmitted to the second MLD, such as in the first initial control frame 205 of FIG. 2 (e.g., in an RTS or MU-RTS frame). As discussed above, this initial control frame can include not only an indication of the current TxOP length, but also an indication of the proposed or planned duration (e.g., for how many seconds the first MLD plans to use the link).

At block 710, the MLD determines whether the request was accepted by the second MLD. This may include, for example, determining whether a clear frame (e.g., clear frame 210 of FIG. 2) was received, whether the received clear frame includes a flag or other label indicating that the stay request is accepted, and the like. If the request was not accepted, the method 700 continues to block 715, where the MLD proceeds to use conventional MLO to communicate with the second MLD. That is, because the second MLD declined to stay for the duration, the first MLD can use ordinary techniques and transmit an initial control frame on whichever link it determines to use next.

If, at block 710, the MLD determines that the request was accepted, the method 700 continues to block 720, where the MLD engages in reduced signaling MLO with the MLD. In some embodiments, as discussed above, the MLD can do so by, upon completing the current transmission or TxOP, transmitting one or more additional data frames (e.g., data frames 215 of FIG. 2) for the subsequent TxOP, without first transmitting any initial control frame, such as initial control frame 205 of FIG. 2 (e.g., without sending an RTS or MU-RTS frame to the MLD) and without awaiting a response or clear frame, such as clear frame 210 of FIG. 2 (e.g., without waiting to receive a CTS frame). In this way, the MLO are performed with reduced signaling (e.g., with no initial control frames).

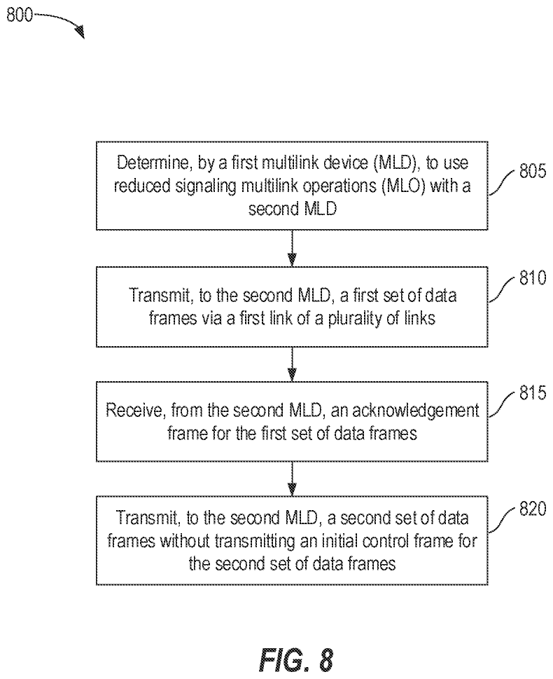

FIG. 8 is a flow diagram depicting an example method for reduced signaling multilink operations. In some embodiments, the method 800 is performed by an AP MLD, such as AP MLD 105 of FIGS. 1 and 2. In some embodiments, the method 800 is performed by a STA MLD, such as STA MLD 115 of FIGS. 1 and 2.

At block 805, a first MLD (e.g., AP MLD 105 or STA MLD 115 of FIGS. 1 and 2) determines to use reduced signaling MLO with a second MLD.

At block 810, a first set of data frames (e.g., data frames 215 of FIG. 2) is transmitted, to the second MLD, via a first link of a plurality of links (e.g., links 125 of FIG. 1).

At block 815, an acknowledgement frame (e.g., acknowledgement frame 220 of FIG. 2) for the first set of data frames is received from the second MLD.

At block 820, a second set of data frames (e.g., data frames 215 of FIG. 2) is transmitted, to the second MLD, without transmitting an initial control frame (e.g., initial control frame 205 of FIG. 2) for the second set of data frames.

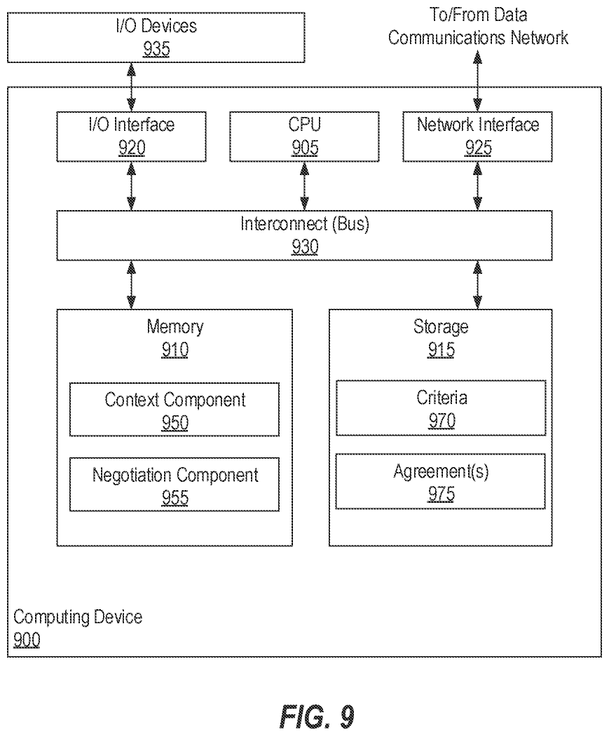

FIG. 9 depicts an example computing device 900 configured to perform various aspects of the present disclosure.

Although depicted as a physical device, in embodiments, the computing device 900 may be implemented using virtual device(s), and/or across a number of devices (e.g., in a cloud environment). In one embodiment, the computing device 900 corresponds to an MLD device, such as the AP MLD 105 of FIGS. 1 and 2, or the STA MLD 115 of FIGS. 1 and 2.

As illustrated, the computing device 900 includes a CPU 905, memory 910, storage 915, a network interface 925, and one or more I/O interfaces 920. In the illustrated embodiment, the CPU 905 retrieves and executes programming instructions stored in memory 910, as well as stores and retrieves application data residing in storage 915. The CPU 905 is generally representative of a single CPU and/or GPU, multiple CPUs and/or GPUs, a single CPU and/or GPU having multiple processing cores, and the like. The memory 910 is generally included to be representative of a random access memory. Storage 915 may be any combination of disk drives, flash-based storage devices, and the like, and may include fixed and/or removable storage devices, such as fixed disk drives, removable memory cards, caches, optical storage, network attached storage (NAS), or storage area networks (SAN).

In some embodiments, I/O devices 935 (such as keyboards, monitors, etc.) are connected via the I/O interface(s) 920. Further, via the network interface 925, the computing device 900 can be communicatively coupled with one or more other devices and components (e.g., via a network, which may include the Internet, local network(s), and the like). As illustrated, the CPU 905, memory 910, storage 915, network interface(s) 925, and I/O interface(s) 920 are communicatively coupled by one or more buses 930.

In the illustrated embodiment, the memory 910 includes a context component 950 and a negotiation component 955, which may perform one or more embodiments discussed above. Although depicted as discrete components for conceptual clarity, in embodiments, the operations of the depicted components (and others not illustrated) may be combined or distributed across any number of components. Further, although depicted as software residing in memory 910, in embodiments, the operations of the depicted components (and others not illustrated) may be implemented using hardware, software, or a combination of hardware and software.

In one embodiment, the context component 950 is used to evaluate the current context of the computing device 900, the other device (with which the computing device 900 is communication) and/or network in order to determine whether reduced signaling MLO should be used, as discussed above. For example, the context component 950 may evaluate network traffic to determine the frequency, frame size, and/or latency-sensitivity of the traffic, or may evaluate the buffer state, the air time being used for MLO initial control frames, and the like. Generally, the context component 950 can determine whether one or more defined criteria are satisfied, such that reduced signaling MLO should be used with one or more devices. However, in some embodiments, as discussed above, the computing device 900 may engage in reduced signaling MLO regardless of such context (e.g., if the other device is capable of using reduced signaling MLO).

The negotiation component 955 may generally be used to negotiate or agree to future MLO link usage, as discussed above. For example, the negotiation component 955 may use TWT, cross-link signaling, requests to stay, duration requests, and the like in order to indicate which link should be used for the subsequent transmission(s).

In the illustrated example, the storage 915 includes a set of criteria 970, and one or more agreements 975. In some embodiments, the criteria 970 corresponds to contextual criteria indicating when or whether reduced signaling MLO is appropriate (such as a minimum frame size, a minimum frame frequency, a binary or continuous value indicating a threshold for latency-sensitivity, a maximum initial control frame air time, and the like). The agreements 975 generally correspond to any agreements or negotiations that have been successfully completed. In an embodiment, the computing device 900 can refer to the agreements 975 to determine whether to use reduced signaling MLO with a given MLD at a given time. Although depicted as residing in storage 915, the criteria 970 and agreements 975 may be stored in any suitable location, including memory 910.

In the current disclosure, reference is made to various embodiments. However, the scope of the present disclosure is not limited to specific described embodiments. Instead, any combination of the described features and elements, whether related to different embodiments or not, is contemplated to implement and practice contemplated embodiments. Additionally, when elements of the embodiments are described in the form of “at least one of A and B,” or “at least one of A or B,” it will be understood that embodiments including element A exclusively, including element B exclusively, and including element A and B are each contemplated. Furthermore, although some embodiments disclosed herein may achieve advantages over other possible solutions or over the prior art, whether or not a particular advantage is achieved by a given embodiment is not limiting of the scope of the present disclosure. Thus, the aspects, features, embodiments and advantages disclosed herein are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

As will be appreciated by one skilled in the art, the embodiments disclosed herein may be embodied as a system, method or computer program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a computer program product embodied in one or more computer readable medium(s) having computer readable program code embodied thereon.

Program code embodied on a computer readable medium may be transmitted using any appropriate medium, including but not limited to wireless, wireline, optical fiber cable, RF, etc., or any suitable combination of the foregoing.

Computer program code for carrying out operations for embodiments of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described herein with reference to flowchart illustrations and/or block diagrams of methods, apparatuses (systems), and computer program products according to embodiments presented in this disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the block(s) of the flowchart illustrations and/or block diagrams.

These computer program instructions may also be stored in a computer readable medium that can direct a computer, other programmable data processing apparatus, or other device to function in a particular manner, such that the instructions stored in the computer readable medium produce an article of manufacture including instructions which implement the function/act specified in the block(s) of the flowchart illustrations and/or block diagrams.

The computer program instructions may also be loaded onto a computer, other programmable data processing apparatus, or other device to cause a series of operational steps to be performed on the computer, other programmable apparatus or other device to produce a computer implemented process such that the instructions which execute on the computer, other programmable data processing apparatus, or other device provide processes for implementing the functions/acts specified in the block(s) of the flowchart illustrations and/or block diagrams.

The flowchart illustrations and block diagrams in the Figures illustrate the architecture, functionality, and operation of possible implementations of systems, methods, and computer program products according to various embodiments. In this regard, each block in the flowchart illustrations or block diagrams may represent a module, segment, or portion of code, which comprises one or more executable instructions for implementing the specified logical function(s). It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, can be implemented by special purpose hardware-based systems that perform the specified functions or acts, or combinations of special purpose hardware and computer instructions.

In view of the foregoing, the scope of the present disclosure is determined by the claims that follow.

We claim:

1. A method, comprising:
determining, by a first multilink device (MLD), to use reduced signaling multilink operations (MLO) with a second MLD;
engaging in reduced signaling MLO with the second MLD, comprising:
transmitting, to the second MLD, a first set of data frames via a first link of a plurality of links;
receiving, from the second MLD, an acknowledgement frame for the first set of data frames; and
transmitting, to the second MLD, a second set of data frames without transmitting an initial control frame for the second set of data frames.

2. The method of claim 1, wherein:
the first set of data frames comprise a request that the second MLD remain on the first link for at least the second set of data frames; and
the acknowledgement frame comprises an acceptance to remain on the first link.

3. The method of claim 1, wherein the first set of data frames comprise an indication that the first MLD will remain on the first link for at least the second set of data frames.

4. The method of claim 1, wherein:
the first set of data frames comprise an indication the first MLD will use a second link, of the plurality of links, for at least the second set of data frames; and
the acknowledgement frame comprises an acceptance to use the second link.

5. The method of claim 1, wherein engaging in reduced signaling MLO with the second MLD comprises:
negotiating a target wake time (TWT) agreement with the second MLD, wherein the TWT agreement indicates to use an indicated TWT link for the first set of data frames at a target time; and
transmitting the first set of data frames at the target time using the indicated TWT link without transmitting an initial control frame for the first set of data frames.

6. The method of claim 1, wherein engaging in reduced signaling MLO with the second MLD comprises:
transmitting, to the second MLD and prior to transmitting the first set of data frames, a first initial control frame indicating:
the first link,
a first duration of time of a transmit opportunity for the reduced signaling MLO on the first link, and
a second duration of time that the first MLD will remain on the first link.

7. The method of claim 1, wherein the reduced signaling MLO comprises transmitting fewer initial control frames to the second MLD, as compared to standard signaling MLO.

8. The method of claim 1, wherein determining to use reduced signaling MLO with the second MLD comprises at least one of:
(i) determining that a current traffic pattern with the second MLD comprises transmitted frames satisfies defined frequency criteria;
(ii) determining that the current traffic pattern with the second MLD comprises transmitted frames satisfies defined size criteria;
(iii) determining that the current traffic with the second MLD is latency-sensitive; or
(iv) determining that a total air time used, by the first MLD, for MLO initial control frames satisfies defined criteria.

9. A non-transitory computer-readable medium containing computer program code that, when executed by operation of one or more computer processors, performs an operation comprising:
determining, by a first multilink device (MLD), to use reduced signaling multilink operations (MLO) with a second MLD;
engaging in reduced signaling MLO with the second MLD, comprising:
transmitting, to the second MLD, a first set of data frames via a first link of a plurality of links;
receiving, from the second MLD, an acknowledgement frame for the first set of data frames; and
transmitting, to the second MLD, a second set of data frames without transmitting an initial control frame for the second set of data frames.

10. The non-transitory computer-readable medium of claim 9, wherein:
the first set of data frames comprise a request that the second MLD remain on the first link for at least the second set of data frames; and
the acknowledgement frame comprises an acceptance to remain on the first link.

11. The non-transitory computer-readable medium of claim 9, wherein:
the first set of data frames comprise an indication the first MLD will use a second link, of the plurality of links, for at least the second set of data frames; and
the acknowledgement frame comprises an acceptance to remain on the first link.

12. The non-transitory computer-readable medium of claim 9, wherein engaging in reduced signaling MLO with the second MLD comprises:
negotiating a target wake time (TWT) agreement with the second MLD, wherein the TWT agreement indicates to use the first link for the first set of data frames at a target time; and
transmitting the first set of data frames at the target time without transmitting an initial control frame for the first set of data frames.

13. The non-transitory computer-readable medium of claim 9, wherein engaging in reduced signaling MLO with the second MLD comprises:
transmitting, to the second MLD and prior to transmitting the first set of data frames, a first initial control frame indicating:
the first link,
a first duration of time of a transmit opportunity for the reduced signaling MLO on the first link, and
a second duration of time that the first MLD will remain on the first link.

14. The non-transitory computer-readable medium of claim 9, wherein the reduced signaling MLO comprises transmitting fewer initial control frames to the second MLD, as compared to standard signaling MLO.

15. The non-transitory computer-readable medium of claim 9, wherein determining to use reduced signaling MLO with the second MLD comprises at least one of:
(i) determining that a current traffic pattern with the second MLD comprises transmitted frames satisfies defined frequency criteria;
(ii) determining that the current traffic pattern with the second MLD comprises transmitted frames satisfies defined size criteria;
(iii) determining that the current traffic with the second MLD is latency-sensitive; or
(iv) determining that a total air time used, by the first MLD, for MLO initial control frames satisfies defined criteria.

16. A system, comprising:
one or more computer processors; and
a memory containing a program which when executed by the one or more computer processors performs an operation, the operation comprising:
determining, by a first multilink device (MLD), to use reduced signaling multilink operations (MLO) with a second MLD;
engaging in reduced signaling MLO with the second MLD, comprising:
transmitting, to the second MLD, a first set of data frames via a first link of a plurality of links;
receiving, from the second MLD, an acknowledgement frame for the first set of data frames; and
transmitting, to the second MLD, a second set of data frames without transmitting an initial control frame for the second set of data frames.

17. The system of claim 16, wherein:
the first set of data frames comprise a request that the second MLD remain on the first link for at least the second set of data frames; and
the acknowledgement frame comprises an acceptance to remain on the first link.

18. The system of claim 16, wherein:
the first set of data frames comprise an indication the first MLD will use a second link, of the plurality of links, for at least the second set of data frames; and
the acknowledgement frame comprises an acceptance to remain on the first link.

19. The system of claim 16, wherein engaging in reduced signaling MLO with the second MLD comprises:
negotiating a target wake time (TWT) agreement with the second MLD, wherein the TWT agreement indicates to use the first link for the first set of data frames at a target time; and
transmitting the first set of data frames at the target time without transmitting an initial control frame for the first set of data frames.

20. The system of claim 16, wherein engaging in reduced signaling MLO with the second MLD comprises:
transmitting, to the second MLD and prior to transmitting the first set of data frames, a first initial control frame indicating:
the first link,
a first duration of time of a transmit opportunity for the reduced signaling MLO on the first link, and
a second duration of time that the first MLD will remain on the first link.
